(19) United States
(12) Patent Application Publication
(10) Pub. No.: US 2005/0023064 A1
(43) Pub. Date: Feb. 3, 2005

(54) Restraint system

(76) Inventors: Thomas Lich, Schwaikheim (DE); Uwe Spieth, Altbach (DE)

Correspondence Address: KENYON & KENYON, ONE BROADWAY, NEW YORK, NY, 10004, US

(21) Appl. No.: 10/644,100

(22) Filed: Aug. 14, 2003

(30) Foreign Application Priority Data
Aug. 14, 2002 (DE) 10237170.9-21

(51) Int. Cl. B60D 1/28; B60L 3/00

(52) U.S. Cl. 180/271

(57) ABSTRACT

Seat springs as the frequency-determining component in a vehicle seat are assigned to an oscillating circuit. When there is a load on the vehicle seat, the inductance of the seat springs changes and thus the resonant frequency of the oscillating circuit changes. Occupancy of a seat is detectable in this way.

### BACKGROUND INFORMATION

Restraint systems according to the related art determine the deployment of restraint means based on the acceleration measured in the tunnel in the passenger compartment or by using peripheral sensors in the exterior area of the vehicle, e.g., in the B pillars. In addition, sensors may be used to determine seat occupancy and/or the sitting position of passengers in the vehicle, to derive therefrom an additional deployment criterion for the restraint means. German Patent Application No. 197 39 655 describes the use of optical sensors, ultrasonic sensors or microwave sensors for this purpose. PCT Patent Publication No. WO 01/15111 also describes the use of a magnetic sensor having a complex structure for detecting seat occupancy. It includes at least two couplable coils, a first coil being assigned to a transmission part of the magnetic sensor and being situated in the seat surface of the vehicle seat, and a second coil being assigned to a reception part of the magnetic sensor and being situated in the backrest of the vehicle seat. A vehicle passenger influences the coupling of these two coils.

### SUMMARY OF THE INVENTION

A much simpler restraint system according to the present invention is nevertheless more reliable in operation. The present invention is based on the finding that conventional components of an automotive seat may be used to implement an additional function, in particular recognition of seat occupancy. Consequently, no structural change in the vehicle seat itself is necessary. This greatly simplifies the production and warehousing of vehicle seats. A shift in resonance is induced based on a change in inductance of traditional seat springs as a component of an oscillating circuit under load. The change in frequency as a function of weight permits a classification of passengers according to weight, for example. Inductive spring elements may be installed easily in the foam used in the vehicle seat. The variety of variants is limited because a specific application based on the seat is eliminated. In addition, the implementation according to the present invention offers the advantage that fault states may be detected and this information relayed further.

Another major advantage is that changes in frequency due to movements of mass are easily analyzable. Such movements of mass occur, for example, when a vehicle passenger changes his/her sitting position.

### BRIEF DESCRIPTION OF THE DRAWINGS

FIG. 1 shows a block diagram of a restraint system designed according to the present invention, in which the vehicle seat permits detection of seat occupancy.

FIG. 2 shows a second exemplary embodiment of the present invention having a plurality of seat springs combined into a group.

FIG. 3 shows a third exemplary embodiment of the present invention, in which each seat spring is connected to an oscillating circuit.

FIG. 4 shows a fourth exemplary embodiment of the present invention having a compensating coil.

FIG. 5 shows a fifth exemplary embodiment of the present invention having seat springs in the seat surface and in the backrest of the vehicle seat.

### DETAILED DESCRIPTION

According to the specifications of U.S. legislation (FMVSS208 of the National Traffic Highway Safety Association), future generations of airbags should allow activation of safety means of a restraint system only as a function of the particular seat occupancy. For example, activation of an airbag is to be allowed when a vehicle seat is occupied by a passenger weighing more than 47.5 kg. However, if a vehicle seat is occupied by a child seat, either activation of the airbag is to be suppressed or the airbag is to be deployed in a controlled manner. This requires systems for monitoring the interior of the vehicle and for recognizing whether an adult person, a child or a child seat is located in the passenger seat. This is easily achieved by utilizing deformation of the vehicle seat due to a load for recognition of the type of seat occupancy.

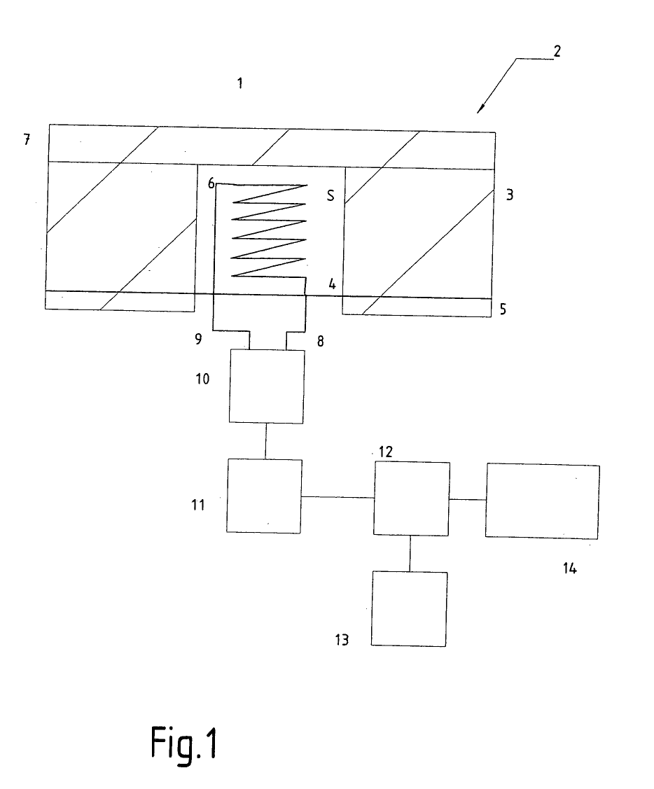

FIG. 1 shows a block diagram of a restraint system 1 designed according to the present invention, in which a vehicle seat 2 having a suitable design permits detection of seat occupancy. Vehicle seat 2 is shown schematically in cross section. A seat spring S designed as a helical spring is provided inside of seat cushion 3 and is supported with one end piece 4 on a carrier plate 5, and with its other end piece 6 it supports seat surface 7 of seat cushion 3. End pieces 4, 6 of seat spring S are connected to an oscillating circuit 10 by lines 8, 9. Oscillating circuit 10 is connected to a control unit 11 for sensing passengers. This control unit 11 is in turn connected to an airbag control unit 12. In addition, restraint system 1 has at least one acceleration-sensitive sensor 13 which is connected to airbag control unit 12. At the output, airbag control unit 12 is connected to at least one restraint means, in particular an airbag 14. The function of restraint system 1 is described below. Seat spring S functions as a frequency-determining element for oscillating circuit 10. The principle of the embodiment according to the present invention will now be explained on the example of a seat spring designed as a cylinder coil. The inductance, which depends on length l of the cylinder coil, is determined in approximation by the following equation:
L=(π²*D²*N²/1)*2*10⁻⁷
where:
L is the inductance of the cylinder coil, D is the diameter of the cylinder coil, l is the length of the cylinder coil and N is the number of windings of the cylinder coil. It is apparent from this formula that inductance L of the cylinder coil is inversely proportional to its length l. If such a cylinder coil is used as the frequency-determining element in an oscillating circuit, the result is a change in frequency which depends on the length of the cylinder coil and thus on the load, if the load results in a change in length l.

According to the above formula, inductance L of helical spring S changes with a change in its length l. A change in length l in turn depends on the load on seat 2. Finally, a change in length l results in a change in the resonant frequency of oscillating circuit 10, which is easily detectable by measurement technology. The present invention is based on the finding that the oscillating circuit is detunable as a function of load by using load-dependent inductive elements in the seat as components of an oscillating circuit. This load-dependent detuning of the oscillating circuit permits an unambiguous assignment of the detuning of the oscillating circuit to the weight load on the seat and thus permits a classification of passengers. For example, slight detuning of the oscillating circuit permits the inference that the weight is comparatively small and therefore that the seat is occupied by a child. A great detuning of the oscillating circuit permits the conclusion that the seat is occupied by an adult. In the embodiment according to the present invention, the seat springs themselves are used as such inductive elements by tying them into at least one electric oscillating circuit as frequency-determining components. Oscillating circuit 10 is connected to control unit 11 for sensing passengers by detecting the load-dependent change in resonant frequency of oscillating circuit 10. It is thus possible to ascertain whether seat 2 is occupied or unoccupied and, if necessary, which sitting position is assumed by the vehicle passenger. The output signal of control unit 11 is sent to airbag control unit 12, which at the same time also analyzes the output signals of acceleration-sensitive sensor 13. If predefined deployment criteria are met, as determined by control unit 12 from the output signals of control unit 11 and sensor 13, then an output signal of control unit 12 will activate restraint means 14.

Essentially one single seat spring S, which forms the frequency-determining component of an oscillating circuit 10, is sufficient to detect the occupancy of a seat 2.

In a particularly advantageous embodiment of the present invention, a plurality of seat springs is assigned to a single oscillating circuit, or a plurality of seat springs is assigned to a plurality of oscillating circuits as the frequency-determining elements in additional exemplary embodiments of the present invention. These exemplary embodiments are described in greater detail below.

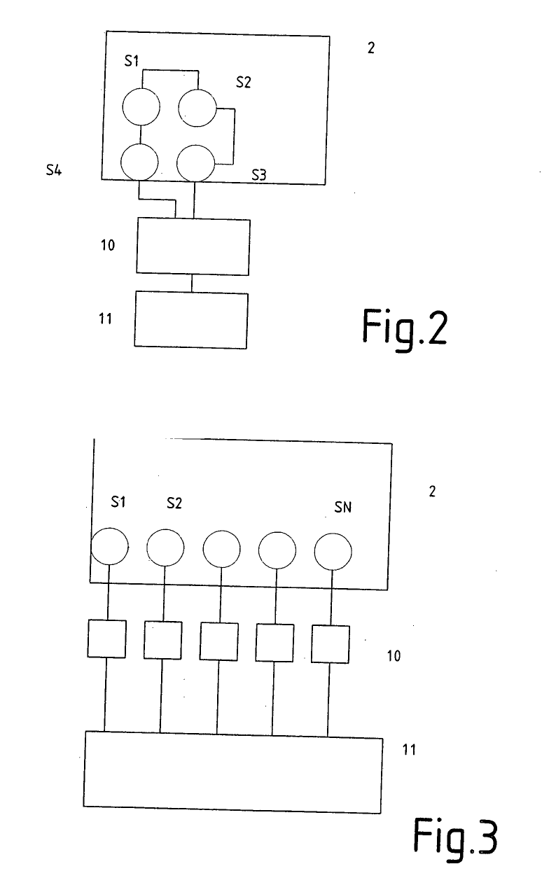

In a second exemplary embodiment of the present invention (FIG. 2), a plurality of seat springs S1, S2, SN are combined into one group and assigned as the frequency-determining elements to a single oscillating circuit 10. The plurality of seat springs may be electrically connected in series or in parallel. In addition, a plurality of seat springs situated in proximity to one another or seat springs situated at a mutual spatial distance may be combined electrically to form such a group. A more precise local resolution of the pressure distribution may be achieved through such group configurations of seat springs. This in turn makes it possible to determine the sitting position of a vehicle passenger and even to detect any change in position with a high precision.

In a third exemplary embodiment of the present invention (FIG. 3) a plurality of seat springs S1, S2, SN are situated in a matrix distribution in seat 2. Each seat spring is in turn assigned as the frequency-determining element to one oscillating circuit 10. This exemplary embodiment is characterized by an especially great local resolution of the pressure distribution. Therefore, the sitting position of a vehicle passenger may be determined with an especially great accuracy.

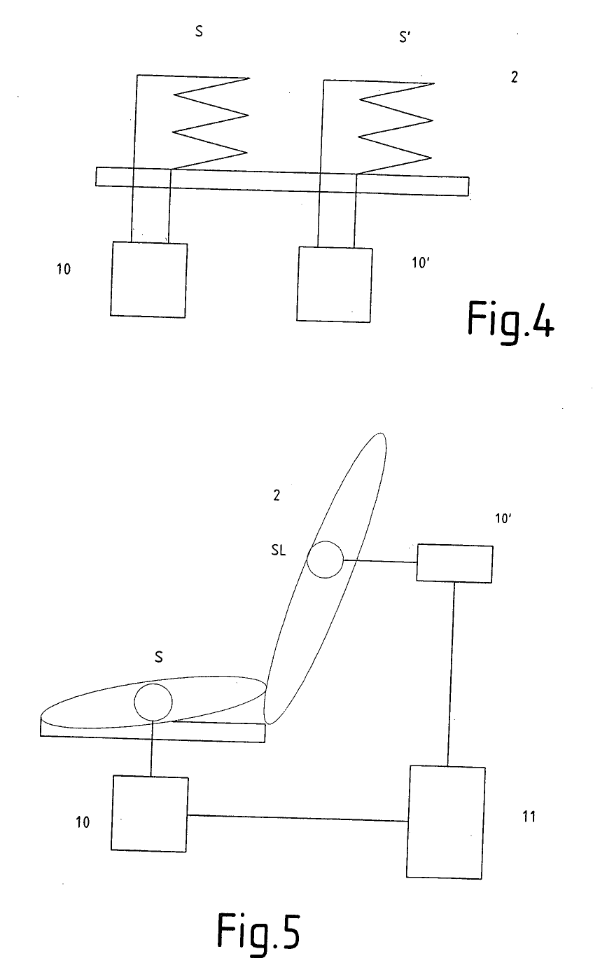

A fourth exemplary embodiment of the present invention is explained on the basis of FIG. 4. In addition, a compensating coil S′ is provided here in the immediate proximity to seat spring S. Compensating coil S′ may be situated either directly next to the seat spring or it may expediently be situated coaxially with the seat spring. The compensating coil is designed so that its inductance is not influenceable by a pressure load on the seat. An unwanted influence due to ferromagnetic objects on the seat is recognizable and compensatable through the configuration of seat spring S and compensating coil S′ described above. In other words, since compensating coil S′ is assigned as the frequency-determining element to a second oscillating circuit 10′, the resonant frequencies of both oscillating circuits 10, 10′ change at the same time. An additional change in the inductance of seat spring S due to a load on seat 2 is measurable as a differential frequency. Another advantage of this exemplary embodiment of the present invention may be seen in the fact that this configuration permits redundant measurement of the seat load. A relative measurement is possible through compensating coil S′, while seat spring S permits an absolute measurement. The second signal, i.e., the relative change, may be used here as a plausibility criterion.

Within the context of the present invention, it is of course also possible to use seat springs SL which are provided in the backrest of seat 2 to determine the position of a passenger. This fifth exemplary embodiment of the present invention is explained on the basis of FIG. 5. A seat spring S, which is integrated into the seat surface of seat 2, is connected to a first oscillating circuit 10. A seat spring SL, which is integrated into the backrest of seat 2, is connected to a second oscillating circuit 10′. Both oscillating circuits 10, 10′ are connected to a control unit 11. As in the exemplary embodiments of the present invention described above, control unit 11 analyzes the changes in the resonant frequencies of oscillating circuits 10, 10′ due to a pressure load on seat springs S, SL and thus permits measurement of the sitting position of a vehicle passenger. This exemplary embodiment is suitable in particular for ascertaining whether the passengers of the vehicle are in contact with the backrest of seat 2.

1. A restraint system for a vehicle, the vehicle having a seat, the restraint system comprising:
at least one restraint device; and
at least one sensor integrated into the vehicle seat for detecting a sitting position of a passenger in the vehicle, the at least one sensor including at least one electric oscillating circuit, the oscillating circuit including a frequency-determining element, the frequency-determining element including at least one seat spring situated in the vehicle seat.

2. The restraint system according to claim 1, further comprising at least one seat spring assigned to at last one of the at least one oscillating circuit.

3. The restraint system according to claim 1, further comprising a plurality of seat springs combined into a group of seat springs assigned to a single one of the at least one oscillating circuit.

4. The restraint system according to claim 3, wherein the seat springs are connected electrically in parallel.

5. The restraint system according to claim 3, wherein the seat springs are connected electrically in series.

6. The restraint system according to claim 1, further comprising a plurality of seat springs situated in a matrix distribution in a seat surface of the seat, each of the seat springs being connected to one of the at least one oscillating circuit.

7. The restraint system according to claim 1, further comprising a compensating coil situated in spacial proximity to the seat spring such that an inductance of the coil does not change when there is a pressure load on the seat.

8. The restraint system according to claim 7, wherein the coil is situated next to the seat spring.

9. The restraint system according to claim 7, wherein the coil is coaxial with the seat spring.

10. The restraint system according to claim 1, wherein the at least one seat spring includes seat springs in the seat and in a backrest of the seat for measuring a seat load on the seat.
